(19) United States
(12) Patent Application Publication
(10) Pub. No.: US 2020/0348973 A1
(43) Pub. Date: Nov. 5, 2020

(54) PERFORMANCE MONITORING AND RESOURCE MANAGEMENT

(71) Applicant: Intel Corporation, Santa Clara, CA (US)

(72) Inventor: Patrick G. KUTCH, Tigard, OR (US)

(21) Appl. No.: 16/923,856

(22) Filed: Jul. 8, 2020

(51) Int. Cl. G06F 9/50; H04L 12/26; H04L 12/911; H04L 12/917; G06F 9/455

(52) U.S. Cl. CPC G06F 9/50; H04L 43/08; H04L 67/10; H04L 47/76; G06F 9/455; H04L 47/827

(57) ABSTRACT

Examples described herein relate to a core executing an application, the application configured to write application performance measurements to one or more telemetry registers associated with the core. In some examples, the one or more telemetry registers can be designated for the application to store performance measurements from the application. In some examples, an orchestrator can read the one or more telemetry registers associated with the core. In some examples, the orchestrator selectively causes modification of resource allocation to the application based on read contents of the one or more telemetry registers. Utilization of the core can be 100% whereas the performance measurements can indicate a level of busyness of the application. In some examples, the performance measurements include one or more of: application busyness level, packets processed over a time interval, number of packets dropped over a time interval, number of video frames processed over a time interval, writes per second, read per second, or number of pending writes.

Cloud computing and mobile device utilization has increased wired and wireless network utilization. In computing networks and data centers, central processing units (CPUs) can be configured to run various network processing operations to rapidly handle network processing of packets. Examples of network processing operations include, but are not limited to, 5G base stations, 5G User Plane Function (UPF) solutions, virtual Cable Modem Termination Systems (CMTS), virtual firewalls, routers, load balancers, and more.

### BRIEF DESCRIPTION OF THE DRAWINGS

FIG. 1 is a block diagram of a processing system.

FIG. 2 depicts an example system.

FIG. 3 depicts an example of telemetry registers for a core.

FIG. 4 depicts an example process.

FIG. 5 depicts an example process.

FIG. 6 depicts a system.

FIG. 7 depicts an example environment.

### DETAILED DESCRIPTION

In some cases, network protocol processing software executes in a virtualized environment such as a virtual machine or a container. Currently, reporting operating health of the network protocol processing software is performed using custom-made software. For example, virtualized environments can report operating health of the network protocol processing software to an orchestrator using a custom-made software socket for network-based communication with the orchestrator. For example, InfluxDB, Grafana, Graphite, or Prometheus monitoring and time series database software can be used to report operating health such as “healthy” or “not healthy.” The orchestrator can increase platform resources allocated to the virtual environment based on the operating health being not healthy or maintain or decrease platform resources allocated to the virtual environment based on the operating health being healthy. Reporting operating health using a network connection socket may lead to reporting operating health information and responding to operating health information too slowly because sending operating health telemetry over a network incurs network traversal-related latency. For example, data provided by a virtual environment over a socket to an orchestrator can incur a delay time of 2-3 seconds until the orchestrator is able to retrieve the operating health telemetry data from when the operating health telemetry data was available and this amount of delay can be unacceptable. By the time the orchestrator adjusts platform resources made available to the virtual environment, the operating heath of the virtual environment may have changed and the allocated resources may no longer fit the current operating conditions.

In some cases, software executing on a platform may be allocated a highest expected resource use of a central processing unit (CPU) frequency as well as cache allocation, memory allocation, and network interface allocation to handle a worst case scenario workload and avoid violating terms of service such as service level agreement (SLA) requirements. For example, CPU utilization can be set at 100% for processes compatible with Data Plane Development Kit (DPDK) or Storage Performance Development Kit (SPDK) that are executing within a virtual environment, even if there are no packets or data to process. However, allocating resources for a worst case scenario can lead to underutilization of resources and increase a total cost of ownership (TCO) of the resources as the resources could be used to execute other software or for other revenue generating uses. Conveying performance or busyness of processes running within a virtual environment can allow for more efficient resource reservation, allocation and utilization.

Various embodiments provide for an application to report particular performance metrics to particular CPU registers and permitting a service assurance agent to directly read the registers without use of a network connection. Various embodiments provide for an operating system (OS) independent manner of reporting metrics. In some examples, the registers are associated with a particular core and the core can execute only one application or type of application so that the service assurance agent can distinctly identify metrics associated with a particular application. For example, applications or workloads can be pinned to run on dedicated, isolated CPU cores that run no other different applications. Non-limiting examples of applications can include DPDK-based applications, SPDK-based applications, media transcoding (e.g., encoding a data in a different format), and so forth.

The service assurance agent can be configured to identify which workload executes on a given CPU core and read performance metrics from registers associated with the performance reporting by the workload. For example, a workload YAML file or description could indicate what type of metrics the service assurance agent reads. The orchestrator can apply a decision scheme that is specific to the workload executing on the core based on current performance metrics, past performance metrics, or trend of performance metrics for the workload.

The service assurance agent can modify resource allocation to the core based on the metrics read from the registers. For example, the service assurance agent can allocate resources to the core on which a workload or application executes by modifying one or more of: an operating frequency of the core, memory allocation to the core, cache allocation to the core, network interface bandwidth allocation to the core, and so forth. For example, based on the metrics for the workload or application running on a core and relative to the standards for that workload or application and the policy for resource modification for that workload or application, if the workload or application is excessively dropping packets or had nearly zero unused cycles, the service assurance agent can increase allocated resource to the core or cause one or more cores to be allocated to execute the application. For example, based on the metrics for the workload or application running on a core and relative to the standards for that workload or application and the policy for resource modification for that workload or application, the service assurance agent can migrate a workload or application to a higher frequency core if the service assurance agent determines that the workload needs more CPU processing power. For example, based on the metrics for the workload or application running on a core and relative to the standards for that workload or application and the policy for resource modification for that workload or application, if the workload or application is considered not busy, the service assurance agent can decrease allocated resource to the core or cause the application to migrate to another core to save power or free resources for uses by other processes or virtual environments.

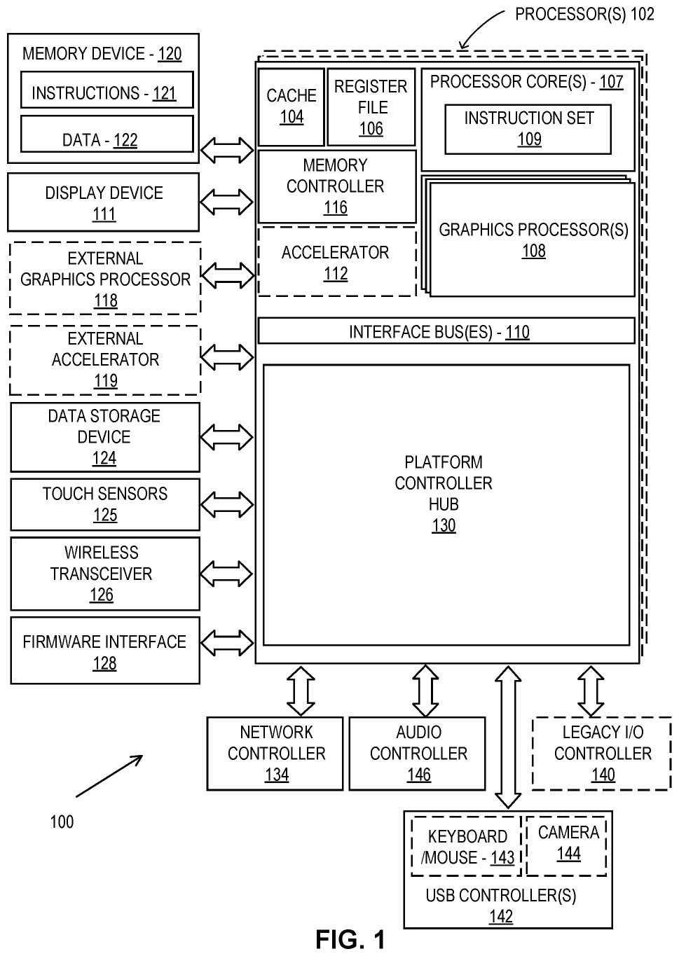

FIG. 1 is a block diagram of a processing system 100, according to an embodiment. System 100 may be used in a single processor desktop system, a multiprocessor workstation system, a server system having a large number of processors 102 or processor cores 107, any rack, row, edge network, or data center. In some embodiments, the system 100 is a processing platform incorporated within a system-on-a-chip (SoC) integrated circuit for use in mobile, handheld, or embedded devices such as within Internet-of-things (IoT) devices with wired or wireless connectivity to a local or wide area network.

In some embodiments, system 100 can include, couple with, or be integrated within: a server-based gaming platform; a game console, including a game and media console; a mobile gaming console, a handheld game console, or an online game console. In some embodiments, the system 100 is part of a mobile phone, smart phone, tablet computing device or mobile Internet-connected device such as a laptop with low internal storage capacity. Processing system 100 can also include, couple with, or be integrated within: a wearable device, such as a smart watch wearable device; smart eyewear or clothing enhanced with augmented reality (AR) or virtual reality (VR) features to provide visual, audio or tactile outputs to supplement real world visual, audio or tactile experiences or otherwise provide text, audio, graphics, video, holographic images or video, or tactile feedback; other augmented reality (AR) device; or other virtual reality (VR) device. In some embodiments, the processing system 100 includes or is part of a television or set top box device. In some embodiments, system 100 can include, couple with, or be integrated within a self-driving vehicle such as a bus, tractor trailer, car, motor or electric power cycle, plane or glider (or any combination thereof). The self-driving vehicle may use system 100 to process the environment sensed around the vehicle.

In some embodiments, the one or more processors 102 each include one or more processor cores 107 to process instructions which, when executed, perform operations for system or user software. In some embodiments, at least one of the one or more processor cores 107 is configured to process a specific instruction set 109. In some embodiments, instruction set 109 may facilitate Complex Instruction Set Computing (CISC), Reduced Instruction Set Computing (RISC), or computing via a Very Long Instruction Word (VLIW). One or more processor cores 107 may process a different instruction set 109, which may include instructions to facilitate the emulation of other instruction sets. Processor core 107 may also include other processing devices, such as a Digital Signal Processor (DSP).

In some embodiments, the processor 102 includes cache memory 104. Cache memory 104 can include Level-0, Level-1 or Level-2 cache. Depending on the architecture, the processor 102 can have a single internal cache or multiple levels of internal cache. In some embodiments, the cache memory is shared among various components of the processor 102. In some embodiments, the processor 102 also uses an external cache (e.g., a Level-3 (L3) cache or Last Level Cache (LLC)) (not shown), which may be shared among processor cores 107 using known cache coherency techniques. A register file 106 can be additionally included in processor 102 and may include different types of registers for storing different types of data (e.g., integer registers, floating point registers, status registers, and an instruction pointer register). Some registers may be general-purpose registers, while other registers may be specific to the design of the processor 102. In some examples, registers may include register banks.

In some examples, register file 106 can include model specific registers (MSR). For example, model specific register (MSR) and/or register file 106 can include control registers used for program execution tracing, toggling of compute features, and/or performance monitoring. The MSR can include one or more of: memory order buffer (MOB) control and status; page fault error codes; clearing of page directory cache and translation lookaside buffer (TLB) entries; control of the various cache memories in the cache hierarchy of the microprocessor, such as disabling portions or all of a cache, removing power from portions or all of a cache, and invalidating cache tags; microcode patch mechanism control; debug control; processor bus control; hardware data and instruction pre-fetch control; power management control, such as sleep and wakeup control, state transitions as defined by Advanced Configuration and Power Interface (ACPI) industry standards (e.g., P-states and C-states), and disabling clocks or power to various functional blocks; control and status of instruction merging; Error-correcting code (ECC) memory error status; bus parity error status; thermal management control and status; service processor control and status; inter-core communication; inter-die communication; functions related to fuses of the microprocessor; voltage regulator module voltage identifier control; phase lock loop (PLL) control; cache snoop control; write-combine buffer control and status; overclocking feature control; interrupt controller control and status; temperature sensor control and status; enabling and disabling of various features, such as encryption/decryption, MSR password protection, making parallel requests to the L2 cache and the processor bus, individual branch prediction features, instruction merging, microinstruction timeout, performance counters, store forwarding, and speculative table walks; load queue size; cache memory size; control of how accesses to undefined MSRs are handled; multi-core configuration; configuration of a cache memory (e.g., de-selecting a column of bit cells in a cache and replacing the column with a redundant column of bit cells), duty cycle and/or clock ratio of phase-locked loops (PLLs) of the microprocessor, and the setting voltage identifier (VID) pins that control a voltage source to the microprocessor.

In some embodiments, one or more processor(s) 102 are coupled with one or more interface bus(es) 110 to transmit communication signals such as address, data, or control signals between processor 102 and other components in the system 100. The interface bus 110, in some embodiments, can be a processor bus, such as a version of the Direct Media Interface (DMI) bus. However, processor busses are not limited to the DMI bus, and may include one or more Peripheral Component Interconnect buses (e.g., PCI, PCI express), memory busses, or other types of interface busses. In some embodiments, the processor(s) 102 include an integrated memory controller 116 and a platform controller hub 130. The memory controller 116 facilitates communication between a memory device and other components of the system 100, while the platform controller hub (PCH) 130 provides connections to I/O devices via a local I/O bus.

The memory device 120 can be a dynamic random-access memory (DRAM) device, a static random-access memory (SRAM) device, flash memory device, phase-change memory device, or some other memory device having suitable performance to serve as process memory. In some embodiments, the memory device 120 can operate as system memory for the system 100, to store data 122 and instructions 121 for use when the one or more processors 102 executes an application or process. Memory controller 116 also couples with an optional external graphics processor 118, which may communicate with the one or more graphics processors 108 in processors 102 to perform graphics and media operations. In some embodiments, graphics, media, and or compute operations may be assisted by an accelerator 112 which is a coprocessor that can be configured to perform a specialized set of graphics, media, or compute operations. For example, in some embodiments, the accelerator 112 is a matrix multiplication accelerator used to optimize machine learning or compute operations. In some embodiments, the accelerator 112 includes a ray-tracing accelerator that can be used to perform ray-tracing operations in concert with the graphics processor 108. In some embodiments, an external accelerator 119 may be used in place of or in concert with the accelerator 112.

In some embodiments, a display device 111 can connect to the processor(s) 102. The display device 111 can be one or more of an internal display device, as in a mobile electronic device or a laptop device or an external display device attached via a display interface (e.g., DisplayPort, embedded DisplayPort, MIPI, HDMI, etc.). In some embodiments, the display device 111 can be a head mounted display (HMD) such as a stereoscopic display device for use in virtual reality (VR) applications or augmented reality (AR) applications.

In some embodiments, the platform controller hub 130 enables peripherals to connect to memory device 120 and processor 102 via a high-speed I/O bus. The I/O peripherals include, but are not limited to, an audio controller 146, a network controller 134, a firmware interface 128, a wireless transceiver 126, touch sensors 125, a data storage device 124 (e.g., non-volatile memory, volatile memory, hard disk drive, flash memory, NAND, 3D NAND, 3D XPoint, etc.). The data storage device 124 can connect via a storage interface (e.g., SATA) or via a peripheral bus, such as a Peripheral Component Interconnect bus (e.g., PCI, PCI express). The touch sensors 125 can include touch screen sensors, pressure sensors, or fingerprint sensors. The wireless transceiver 126 can be a Wi-Fi transceiver, a Bluetooth transceiver, or a mobile network transceiver such as a 3G, 4G, 5G, or Long-Term Evolution (LTE) transceiver. The firmware interface 128 enables communication with system firmware, and can be, for example, a unified extensible firmware interface (UEFI). The network controller 134 can enable a network connection to a wired network. In some embodiments, a high-performance network controller (not shown) couples with the interface bus 110. The audio controller 146, in some embodiments, is a multi-channel high definition audio controller. In some embodiments, the system 100 includes an optional legacy I/O controller 140 for coupling legacy (e.g., Personal System 2 (PS/2)) devices to the system. The platform controller hub 130 can also connect to one or more Universal Serial Bus (USB) controllers 142 connect input devices, such as keyboard and mouse 143 combinations, a camera 144, or other USB input devices.

It will be appreciated that the system 100 shown is exemplary and not limiting, as other types of data processing systems that are differently configured may also be used. For example, an instance of the memory controller 116 and platform controller hub 130 may be integrated into a discreet external graphics processor, such as the external graphics processor 118. In some embodiments, the platform controller hub 130 and/or memory controller 116 may be external to the one or more processor(s) 102. For example, the system 100 can include an external memory controller 116 and platform controller hub 130, which may be configured as a memory controller hub and peripheral controller hub within a system chipset that is in communication with the processor(s) 102.

For example, circuit boards (“sleds”) can be used on which components such as CPUs, memory, and other components are placed are designed for increased thermal performance. In some examples, processing components such as the processors are located on a top side of a sled while near memory, such as dual in-line memory modules (DIMMs), are located on a bottom side of the sled. As a result of the enhanced airflow provided by this design, the components may operate at higher frequencies and power levels than in typical systems, thereby increasing performance. Furthermore, the sleds are configured to blindly mate with power and data communication cables in a rack, thereby enhancing their ability to be quickly removed, upgraded, reinstalled, and/or replaced. Similarly, individual components located on the sleds, such as processors, accelerators, memory, and data storage drives, are configured to be easily upgraded due to their increased spacing from each other. In the illustrative embodiment, the components additionally include hardware attestation features to prove their authenticity.

A data center can utilize a single network architecture (“fabric”) that supports multiple other network architectures including Ethernet and Omni-Path. The sleds can be coupled to switches via optical fibers, which provide higher bandwidth and lower latency than typical twisted pair cabling (e.g., Category 5, Category 5e, Category 6, etc.). Due to the high bandwidth, low latency interconnections and network architecture, the data center may, in use, pool resources, such as memory, accelerators (e.g., GPUs, graphics accelerators, FPGAs, ASICs, neural network and/or artificial intelligence accelerators, etc.), and data storage drives that are physically disaggregated, and provide them to compute resources (e.g., processors) on an as needed basis, enabling the compute resources to access the pooled resources as if they were local.

A power supply or source can provide voltage and/or current to system 100 or any component or system described herein. In one example, the power supply includes an AC to DC (alternating current to direct current) adapter to plug into a wall outlet. Such AC power can be renewable energy (e.g., solar power) power source. In one example, power source includes a DC power source, such as an external AC to DC converter. In one example, power source or power supply includes wireless charging hardware to charge via proximity to a charging field. In one example, power source can include an internal battery, alternating current supply, motion-based power supply, solar power supply, or fuel cell source.

Any processor or core can execute a virtualized execution environment. A virtualized execution environment (VEE) can include at least a virtual machine or a container. VEEs can execute in bare metal (e.g., single tenant) or hosted (e.g., multiple tenants) environments. A virtual machine (VM) can be software that runs an operating system and one or more applications. A VM can be defined by specification, configuration files, virtual disk file, non-volatile random access memory (NVRAM) setting file, and the log file and is backed by the physical resources of a host computing platform. A VM can be an OS or application environment that is installed on software, which imitates dedicated hardware. The end user has the same experience on a virtual machine as they would have on dedicated hardware. Specialized software, called a hypervisor, emulates the PC client or server's CPU, memory, hard disk, network and other hardware resources completely, enabling virtual machines to share the resources. The hypervisor can emulate multiple virtual hardware platforms that are isolated from each other, allowing virtual machines to run Linux®, FreeBSD, VMWare, or Windows® Server operating systems on the same underlying physical host.

A container can be a software package of applications, configurations and dependencies so the applications run reliably on one computing environment to another. Containers can share an operating system installed on the server platform and run as isolated processes. A container can be a software package that contains everything the software needs to run such as system tools, libraries, and settings. Containers are not installed like traditional software programs, which allows them to be isolated from the other software and the operating system itself. Isolation can include permitted access of a region of addressable memory or storage by a particular container but not another container. The isolated nature of containers provides several benefits. First, the software in a container will run the same in different environments. For example, a container that includes PHP and MySQL can run identically on both a Linux computer and a Windows® machine. Second, containers provide added security since the software will not affect the host operating system. While an installed application may alter system settings and modify resources, such as the Windows® registry, a container can only modify settings within the container.

A virtualized infrastructure manager (VIM) or hypervisor (not shown) can manage the life cycle of a VEE (e.g., creation, maintenance, and tear down of VEEs associated with one or more physical resources), track VEE instances, track performance, fault and security of VEE instances and associated physical resources, and expose VEE instances and associated physical resources to other management systems.

For example, an application, workload or software can execute within a VEE in a bare metal or multi-tenant environment. In some embodiments, the application, workload or software executes on one or more dedicated cores and the core do not run a different application but can run multiple instances of an application. A CPU core can expose a number of telemetry registers (TMR) that software or a VEE can access. For example, register file 106 can include telemetry registers (TMR). In some embodiments, an application or other software executing on a particular core can write specific performance metrics to one or more particular TMRs in register file 106. The software can then write specific performance or telemetry information to each of the TMR. In some examples, telemetry registers can be hardware registers. In some examples, telemetry registers can be exclusively allocated to store performance or telemetry information. In some examples, telemetry registers can be allocated in memory (e.g., volatile or non-volatile).

In some examples, one or more TMRs can be allocated to an application and a core can be dedicated to execute an application so that a service assurance agent can determine the application's performance or telemetry information that corresponds to contents of a TMR. In some examples, telemetry information written by an application to one or more specific registers may not collide with telemetry information written by another application because only one application runs on the core. In some examples, only an application running on a core is permitted to write to a particular one or more TMRs of a core.

The service assurance agent can be configured to recognize content that telemetry information conveys (e.g., dropped packets per time interval, busyness level, packet processing activity (e.g., packets processed per time interval), video frames processed per time interval and so forth) based on a particular register into which content is written. A mapping of telemetry information type or content to specific TMR can be conveyed via a description of the workload (e.g., in attributes for a Kubernetes deployable unit (e.g., Pod)). The service assurance agent can pin certain applications or software to particular cores for execution and identify the type of corresponding telemetry information for the application based on which specific TMR was read and the application that is permitted to write to the TMR. The service assurance agent can be configured to apply a particular resource allocation scheme for a particular application where the scheme specifies how the service assurance agent is to modify the resources allocated to the application based on measured telemetry information. For example, the service assurance agent can receive information from a performance monitoring unit (PMU) that conveys branch hit/miss ratio that indicates busyness from the processing of received packets or processor idleness.

The service assurance agent can be granted privileges (e.g., roots of trust (RoT) or kernel level privileges) so that the service assurance agent can change resource settings to suit the needs of the application workload. To modify power, frequency, memory allocation, or cache settings of the core(s), service assurance agent can instruct the OS to perform those settings or with sufficient privilege, the service assurance agent can write to specific registers files to set operating parameters.

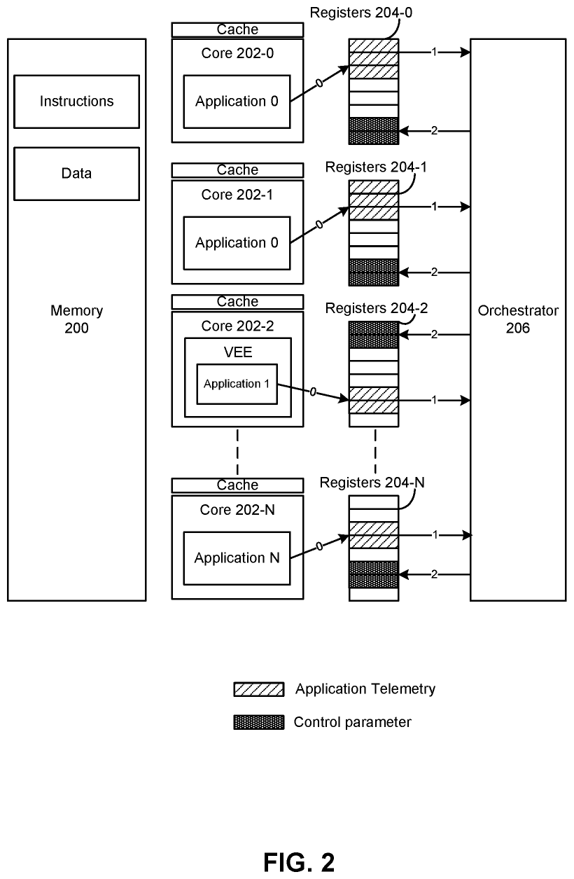

FIG. 2 depicts an example system. The system can be used to share performance telemetry by writing the performance telemetry into one or more registers and the system can configure resource allocation based on the performance telemetry values or indicators. Memory 200 can store instructions for execution in an application or application executed within a VEE by any of cores 202-0 to 202-N, where N is an integer and greater than or equal to 3. Any number of cores can be used including one or two cores. An application executing on cores 202-0 to 202-N can write to or read from respective registers 204-0 to 204-N. In some examples, a single application is executed on a core and a different application is not executed on the core. For example, if the application is executed within a VEE, only a single instance of the application is executed within a VEE on a core. In some examples, an application is configured to write application telemetry information to one or more particular registers and no other application can write to those registers. For each of cores 202-0 to 202-N, respective registers 204-0 to 204-N can include telemetry registers that are allocated to store application telemetry such as a bank of registers tmr0 to tmr15, although any number of telemetry registers can be supported. In some examples, some cores do not have any associated telemetry registers.

For example, as shown in FIG. 2, instances of application 0 running on cores 202-0 and 202-1 can be configured to write application telemetry to the same particular registers among registers 204-0 and 204-1 or one of registers 204-0 and 204-1. As shown, application 1 executing within a VEE on core 202-2 can be configured to write application telemetry information to particular registers in registers 204-2. As shown, application N executing on core 202-N can be configured to write application telemetry to particular registers in registers 204-N. For example, for a DPDK-based VNF application running in a VEE, the VNF application can write telemetry to a core's telemetry registers on which the DPDK application is assigned.

In some examples, an application or software is configured to write to specific registers in a register file or bank. An application developer can encode the application or software to write telemetry information to one or more registers (if the telemetry sharing feature is supported) and what telemetry information to write in each register. For example, an application or software can query a CPU or operating system to learn capabilities such as but not limited to CPU capabilities such as telemetry sharing capabilities via telemetry registers, Streaming SIMD Extensions (SSE) support, type of floating point support, and so forth. For DPDK or SPDK, libraries can be available to configure an application to write telemetry information to specific registers or for an orchestrator to read telemetry information from particular registers. A report telemetry application program interface (API) (e.g., written in C++) can be made available for a developer to use and an application compiler (e.g., compile-time or run-time) can generate a machine language version of the application configured to write telemetry information to one or more telemetry registers in a register file or bank.

For example, the following pseudocode can represent instructions that configure an application to write application telemetry to a telemetry register 0 a value 80 in a register file for a core that the application runs.
mov tmr0, 80
   The value 80 can represent a level of busyness of the application.

An application can write application telemetry to particular telemetry registers on the core(s) on which the application executes at a time interval or for other triggers such as a per loop or per interval basis. If there is nothing to report for a specific telemetry component, then a “0” or some other specific value known to the workload can be written to a register and orchestrator 206 can identify there is no new or different telemetry information reported. In cases where no new or different telemetry information is reported, orchestrator 206 can elect to no perform any determination of whether to adjust resource allocation to the core or application and thereby save power or CPU cycles.

For example, an application, workload, or software can perform packet processing based on one or more of Data Plane Development Kit (DPDK), Storage Performance Development Kit (SPDK), OpenDataPlane, Network Function Virtualization (NFV), software-defined networking (SDN), Evolved Packet Core (EPC), or 5G network slicing. Some example implementations of NFV are described in European Telecommunications Standards Institute (ETSI) specifications or Open Source NFV Management and Orchestration (MANO) from ETSI's Open Source Mano (OSM) group. A virtual network function (VNF) can include a service chain or sequence of virtualized tasks executed on generic configurable hardware such as firewalls, domain name system (DNS), caching or network address translation (NAT) and can run in VEEs. VNFs can be linked together as a service chain. In some examples, EPC is a 3GPP-specified core architecture at least for Long Term Evolution (LTE) access. 5G network slicing can provide for multiplexing of virtualized and independent logical networks on the same physical network infrastructure. Some applications can perform video processing or media transcoding (e.g., changing the encoding of audio, image or video files).

Orchestrator 206 can read particular registers associated with each core and the registers store application telemetry. For example, orchestrator 206 can periodically poll for updates to a particular one or more telemetry registers for one or more cores. For example, orchestrator 206 can be configured to read from one or more particular registers using pseudo code such as examples below to move, copy or read contents of a telemetry register of a particular core number 34 and read contents of a telemetry registe number 5 and write the contents into an Extended Accumulator Register (EAX).
mov eax, 34 // read TMR from core #34
rtmr eax, 5 // get contents of TMR5 (for core 34) and put in EAX

Orchestrator 206 can operate independent of a type of utilized operating system (OS). Orchestrator 206 can securely access register content that is not transferred over a network in a packet. Orchestrator 206 can operate on a same CPU or different CPU as that of any register that is being read or updated, the same server or different server as that of any register that is being read or updated, the same rack or different rack as that of any register that is being read or updated, the same row of racks or different row of racks as that of any register that is being read or updated, or the same data center or different data center as that of any register that is being read or updated.

Orchestrator 206 can utilize application telemetry to determine whether to affect changes to resource allocation to an application. For an application running on a core, changes may include changing cache allocation to the core, adjusting CPU frequency of the core, changing memory allocation to the core, changing network interface bandwidth allocated to the core, and so forth. Orchestrator 206 can be configured to correlate an application's telemetry information to adjust resource allocation to improve performance or stability of the application or reduce power of the core. For example, orchestrator 206 can move the application to a slower CPU core because the application is not actively using all of the core it is currently assigned to and place the former core in a sleep or lower power consuming state or lower operating frequency state. In some examples, if the application shows low core utilization, orchestrator 206 can cause the application to be executed in a VEE with one or more different applications on a core.

Orchestrator 206 can adjust core operating parameters by requesting an OS to adjust power or frequency allocated to a core. In some examples, orchestrator 206 can be granted privileges (e.g., roots of trust (RoT) or kernel level privileges) to change core frequency or cache allocation settings. Orchestrator 206 can modify power, frequency, cache settings of core(s) by writing to specific files to set values, and reading from other files to read the current settings.

In some examples, orchestrator 206 can utilize Intel® Resource Director Technology (Intel® RDT) to monitor and control how shared resources such as last-level cache (LLC) and memory bandwidth are used by applications or VEE. the service assurance agent can utilize Cache Allocation Technology (CAT) or Speed Select Technology Base Frequency (SST-BF) to monitor and control how shared resources such as cache allocation (e.g., L-0, L-1, L-2, L-3 or LLC) or set core frequency. In some examples, orchestrator 206 can perform resource allocation that includes modifying server composition such as one or more of: adding or removing core, add or removing allocated addressable memory space, adding or removing an accelerator. In some examples, resources can be disaggregated and composed from resource allocation of devices in a same or different server, same or different rack, same or different row of racks, or same or different data center.

For example, actions 0, 1, and 2 shown in FIG. 2 can correspond to respective (0) an application writing of telemetry information to specific registers, (1) orchestrator 206 reading of telemetry information from specific registers, and (2) orchestrator 206 writing performance parameters to control parameter registers for a core or platform.

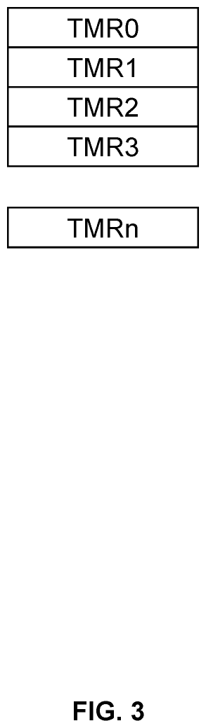

FIG. 3 depicts an example of telemetry registers for a core. Specific telemetry registers (TMR0 to TMRn) can be allocated to store telemetry information that can be read by a service assurance agent such as an orchestrator or rack or multiple rack (e.g., pod) manager. The value n can be an integer that is four or more. The registers can be allocated per core.

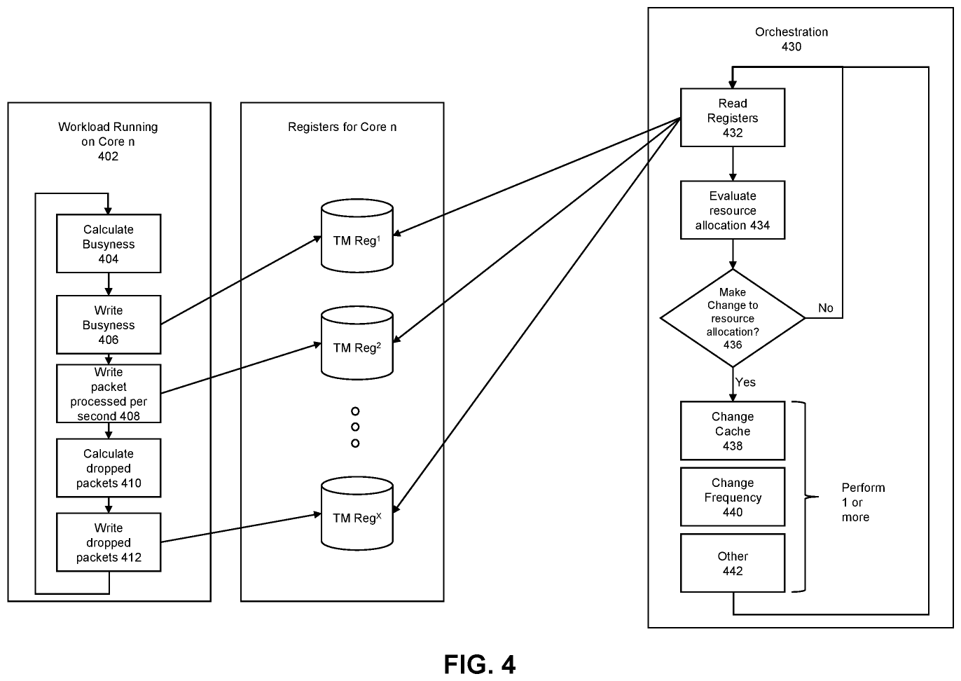

FIG. 4 depicts an example process. A workload 402 (e.g., application or application running in a VEE) running on core n can determine, at 404, its busyness level. For example, busyness level can be determined within a range of 0-100, where level 0 indicates 0 processed packets since last update and level 100 indicates the VNF processed a packet on every loop in the poll mode driver. At 406, the workload can write the busyness level to TM register 1. At 408, the workload can write a number packets processed per second to register TM register 2. At 410, the workload can calculate a number of dropped packets (e.g., how many packets where dropped over the last interval). At 412, the workload can write the number of dropped packets to TM register x.

At 432, orchestration 430 can read telemetry registers of core n. At 434, orchestration can determine resource allocation to the core n based on telemetry register contents. At 436, orchestration can determine whether to adjust the resource allocation to the core n based on the telemetry information. For example, if the telemetry information indicates the core is able to perform the workload and meet applicable performance requirements, no changes in resource allocation can take place and the process can return to 432. For example, if the telemetry information indicates the core is underutilized or unable to handle the workload while meeting applicable performance requirements, orchestration can proceed to 438, 440, and 442.

Orchestration 430 can be configured to perform one or more of 438, 440, and 442 to reduce resources to the core or application or provide additional resources to the core or application to perform the workload. For example, 438 can include increasing or decreasing cache allocation (e.g., L-0, L-1, L-2, LLC) to the core or its workload. For example, 440 can include increasing or decreasing frequency of operation of core n. For example, 442 can include increasing or decreasing memory or bandwidth allocation to the core or its workload. Other resource allocation changes can be made such as changes to server composition (e.g., changing locally accessible resources of a server or fabric or network accessible resources of a server).

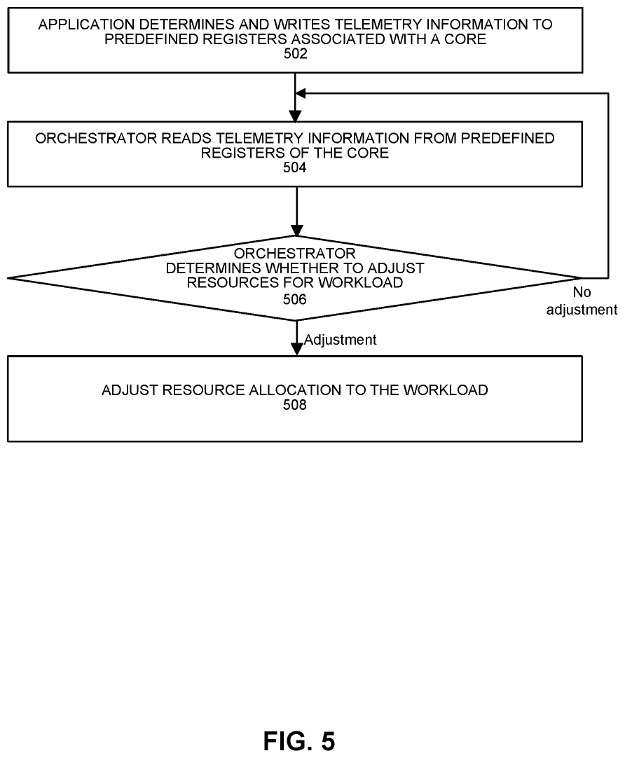

FIG. 5 depicts an example process. At 502, an application can determine and write specific performance information to particular one or more registers of a core. In some examples, the application is executed on a core and the core executes no different application. In some examples, the core executes merely one instance or an application. For example, the application can execute within a VEE that executes on a specific core. The application can be programmed to write particular information to specific registers of the core.

At 504, an orchestrator can read performance information from particular registers of the core. Register content and specific types of telemetry information (e.g., busyness, packet drops per unit of time, packets processed per unit of time, and so forth) can be attributed to the application via a configuration. For example, for SPDK-based workloads executed by a core, register content can specify one or more of: writes per second, read per second, or number of pending writes. The configuration can be defined in a description of the application (e.g., in attributes for a Kubernetes POD) or YAML file. At 506, the orchestrator can determine whether to adjust resource allocation to the workload running on the core. For example, the orchestrator can determine to adjust resource allocation based on specific performance requirements for the application and a particular resource adjustment scheme for the application. For example, if performance requirements are violated, resource allocation can be adjusted according to the resource adjustment scheme. For example, if performance requirements are not violated, resource allocation can be maintained or adjusted to reduce power use according to the resource adjustment scheme. If a resource allocation is not to be adjusted, the process can return to 504. If a resource allocation is to be adjusted, the process can continue to 508.

At 508, the orchestrator can adjust resource allocation to a core or workload. For example, if performance requirements are violated, according to the resource adjustment scheme for the application, the orchestrator can perform one or more of: increase frequency of the core, increase of cache allocation, increase of memory allocation, increase of network interface bandwidth for the application, or adjust a composition of a server (e.g., adjust disaggregated resources allocated to the server). For example, if performance requirements are not violated, according to the resource adjustment scheme for the application, the orchestrator can perform one or more of: decrease frequency of the core, decrease of cache allocation, decrease of memory allocation, or decrease of network interface bandwidth for the application. In some examples, the orchestrator can cause migration of the application to another core and cause the former core to sleep according to the resource adjustment scheme for the application.

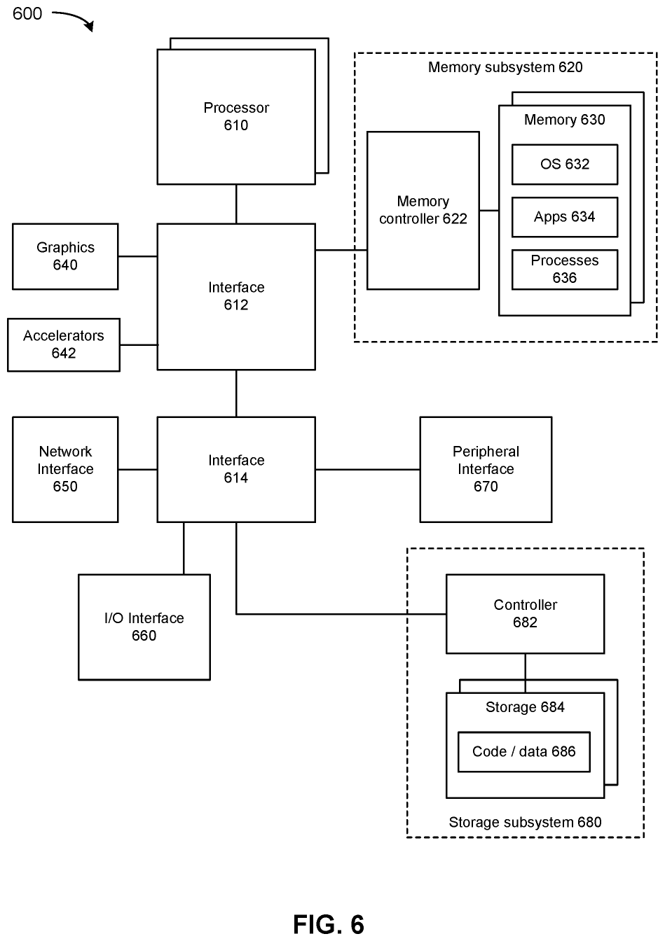

FIG. 6 depicts a system. The system can use embodiments described herein to write telemetry information to registers and adjust resource allocation according to an application resource adjustment scheme. System 600 includes processor 610, which provides processing, operation management, and execution of instructions for system 600. Processor 610 can include any type of microprocessor, central processing unit (CPU), graphics processing unit (GPU), processing core, or other processing hardware to provide processing for system 600, or a combination of processors. Processor 610 controls the overall operation of system 600, and can be or include, one or more programmable general-purpose or special-purpose microprocessors, digital signal processors (DSPs), programmable controllers, application specific integrated circuits (ASICs), programmable logic devices (PLDs), or the like, or a combination of such devices.

In one example, system 600 includes interface 612 coupled to processor 610, which can represent a higher speed interface or a high throughput interface for system components that needs higher bandwidth connections, such as memory subsystem 620 or graphics interface components 640, or accelerators 642. Interface 612 represents an interface circuit, which can be a standalone component or integrated onto a processor die. Where present, graphics interface 640 interfaces to graphics components for providing a visual display to a user of system 600. In one example, graphics interface 640 can drive a high definition (HD) display that provides an output to a user. High definition can refer to a display having a pixel density of approximately 100 PPI (pixels per inch) or greater and can include formats such as full HD (e.g., 1080 p), retina displays, 4K (ultra-high definition or UHD), or others. In one example, the display can include a touchscreen display. In one example, graphics interface 640 generates a display based on data stored in memory 630 or based on operations executed by processor 610 or both. In one example, graphics interface 640 generates a display based on data stored in memory 630 or based on operations executed by processor 610 or both.

Accelerators 642 can be a programmable or fixed function offload engine that can be accessed or used by a processor 610. For example, an accelerator among accelerators 642 can provide compression (DC) capability, cryptography services such as public key encryption (PKE), cipher, hash/authentication capabilities, decryption, or other capabilities or services. In some embodiments, in addition or alternatively, an accelerator among accelerators 642 provides field select controller capabilities as described herein. In some cases, accelerators 642 can be integrated into a CPU socket (e.g., a connector to a motherboard or circuit board that includes a CPU and provides an electrical interface with the CPU). For example, accelerators 642 can include a single or multi-core processor, graphics processing unit, logical execution unit single or multi-level cache, functional units usable to independently execute programs or threads, application specific integrated circuits (ASICs), neural network processors (NNPs), programmable control logic, and programmable processing elements such as field programmable gate arrays (FPGAs). Accelerators 642 can provide multiple neural networks, CPUs, processor cores, general purpose graphics processing units, or graphics processing units can be made available for use by artificial intelligence (AI) or machine learning (ML) models. For example, the AI model can use or include any or a combination of: a reinforcement learning scheme, Q-learning scheme, deep-Q learning, or Asynchronous Advantage Actor-Critic (A3C), combinatorial neural network, recurrent combinatorial neural network, or other AI or ML model. Multiple neural networks, processor cores, or graphics processing units can be made available for use by AI or ML models.

Memory subsystem 620 represents the main memory of system 600 and provides storage for code to be executed by processor 610, or data values to be used in executing a routine. Memory subsystem 620 can include one or more memory devices 630 such as read-only memory (ROM), flash memory, one or more varieties of random access memory (RAM) such as DRAM, or other memory devices, or a combination of such devices. Memory 630 stores and hosts, among other things, operating system (OS) 632 to provide a software platform for execution of instructions in system 600. Additionally, applications 634 can execute on the software platform of OS 632 from memory 630. Applications 634 represent programs that have their own operational logic to perform execution of one or more functions. Processes 636 represent agents or routines that provide auxiliary functions to OS 632 or one or more applications 634 or a combination. OS 632, applications 634, and processes 636 provide software logic to provide functions for system 600. In one example, memory subsystem 620 includes memory controller 622, which is a memory controller to generate and issue commands to memory 630. It will be understood that memory controller 622 could be a physical part of processor 610 or a physical part of interface 612. For example, memory controller 622 can be an integrated memory controller, integrated onto a circuit with processor 610.

While not specifically illustrated, it will be understood that system 600 can include one or more buses or bus systems between devices, such as a memory bus, a graphics bus, interface buses, or others. Buses or other signal lines can communicatively or electrically couple components together, or both communicatively and electrically couple the components. Buses can include physical communication lines, point-to-point connections, bridges, adapters, controllers, or other circuitry or a combination. Buses can include, for example, one or more of a system bus, a Peripheral Component Interconnect (PCI) bus, a Hyper Transport or industry standard architecture (ISA) bus, a small computer system interface (SCSI) bus, a universal serial bus (USB), or an Institute of Electrical and Electronics Engineers (IEEE) standard 1394 bus (Firewire).

In one example, system 600 includes interface 614, which can be coupled to interface 612. In one example, interface 614 represents an interface circuit, which can include standalone components and integrated circuitry. In one example, multiple user interface components or peripheral components, or both, couple to interface 614. Network interface 650 provides system 600 the ability to communicate with remote devices (e.g., servers or other computing devices) over one or more networks. Network interface 650 can include an Ethernet adapter, wireless interconnection components, cellular network interconnection components, USB (universal serial bus), or other wired or wireless standards-based or proprietary interfaces. Network interface 650 can transmit data to a device that is in the same data center or rack or a remote device, which can include sending data stored in memory. Network interface 650 can receive data from a remote device, which can include storing received data into memory. Various embodiments can be used in connection with network interface 650, processor 610, and memory subsystem 620.

In one example, system 600 includes one or more input/output (I/O) interface(s) 660. I/O interface 660 can include one or more interface components through which a user interacts with system 600 (e.g., audio, alphanumeric, tactile/touch, or other interfacing). Peripheral interface 670 can include any hardware interface not specifically mentioned above. Peripherals refer generally to devices that connect dependently to system 600. A dependent connection is one where system 600 provides the software platform or hardware platform or both on which operation executes, and with which a user interacts.

In one example, system 600 includes storage subsystem 680 to store data in a nonvolatile manner. In one example, in certain system implementations, at least certain components of storage 680 can overlap with components of memory subsystem 620. Storage subsystem 680 includes storage device(s) 684, which can be or include any conventional medium for storing large amounts of data in a nonvolatile manner, such as one or more magnetic, solid state, or optical based disks, or a combination. Storage 684 holds code or instructions and data 686 in a persistent state (e.g., the value is retained despite interruption of power to system 600). Storage 684 can be generically considered to be a “memory,” although memory 630 is typically the executing or operating memory to provide instructions to processor 610. Whereas storage 684 is nonvolatile, memory 630 can include volatile memory (e.g., the value or state of the data is indeterminate if power is interrupted to system 600). In one example, storage subsystem 680 includes controller 682 to interface with storage 684. In one example controller 682 is a physical part of interface 614 or processor 610 or can include circuits or logic in both processor 610 and interface 614.

A volatile memory is memory whose state (and therefore the data stored in it) is indeterminate if power is interrupted to the device. Dynamic volatile memory requires refreshing the data stored in the device to maintain state. One example of dynamic volatile memory incudes DRAM (Dynamic Random Access Memory), or some variant such as Synchronous DRAM (SDRAM). Another example of volatile memory includes cache or static random access memory (SRAM). A memory subsystem as described herein may be compatible with a number of memory technologies, such as DDR3 (Double Data Rate version 3, original release by JEDEC (Joint Electronic Device Engineering Council) on Jun. 27, 2007). DDR4 (DDR version 4, initial specification published in September 2012 by JEDEC), DDR4E (DDR version 4), LPDDR3 (Low Power DDR version3, JESD209-3B, August 2013 by JEDEC), LPDDR4) LPDDR version 4, JESD209-4, originally published by JEDEC in August 2014), WIO2 (Wide Input/output version 2, JESD229-2 originally published by JEDEC in August 2014, HBM (High Bandwidth Memory, JESD325, originally published by JEDEC in October 2013, LPDDR5 (currently in discussion by JEDEC), HBM2 (HBM version 2), currently in discussion by JEDEC, or others or combinations of memory technologies, and technologies based on derivatives or extensions of such specifications. The JEDEC standards are available at www.jedec.org.

A non-volatile memory (NVM) device is a memory whose state is determinate even if power is interrupted to the device. In some embodiments, the NVM device can comprise a block addressable memory device, such as NAND technologies, or more specifically, multi-threshold level NAND flash memory (for example, Single-Level Cell (“SLC”), Multi-Level Cell (“MLC”), Quad-Level Cell (“QLC”), Tri-Level Cell (“TLC”), or some other NAND). A NVM device can also comprise a byte-addressable write-in-place three dimensional cross point memory device, or other byte addressable write-in-place NVM device (also referred to as persistent memory), such as single or multi-level Phase Change Memory (PCM) or phase change memory with a switch (PCMS), Intel® Optane™ memory, NVM devices that use chalcogenide phase change material (for example, chalcogenide glass), resistive memory including metal oxide base, oxygen vacancy base and Conductive Bridge Random Access Memory (CB-RAM), nanowire memory, ferroelectric random access memory (FeRAM, FRAM), magneto resistive random access memory (MRAM) that incorporates memristor technology, spin transfer torque (STT)-MRAM, a spintronic magnetic junction memory based device, a magnetic tunneling junction (MTJ) based device, a DW (Domain Wall) and SOT (Spin Orbit Transfer) based device, a thyristor based memory device, or a combination of any of the above, or other memory.

A power source (not depicted) provides power to the components of system 600. More specifically, power source typically interfaces to one or multiple power supplies in system 600 to provide power to the components of system 600. In one example, the power supply includes an AC to DC (alternating current to direct current) adapter to plug into a wall outlet. Such AC power can be renewable energy (e.g., solar power) power source. In one example, power source includes a DC power source, such as an external AC to DC converter. In one example, power source or power supply includes wireless charging hardware to charge via proximity to a charging field. In one example, power source can include an internal battery, alternating current supply, motion-based power supply, solar power supply, or fuel cell source.

In an example, system 600 can be implemented using interconnected compute sleds of processors, memories, storages, network interfaces, and other components. High speed interconnects can be used such as PCIe, Ethernet, or optical interconnects (or a combination thereof).

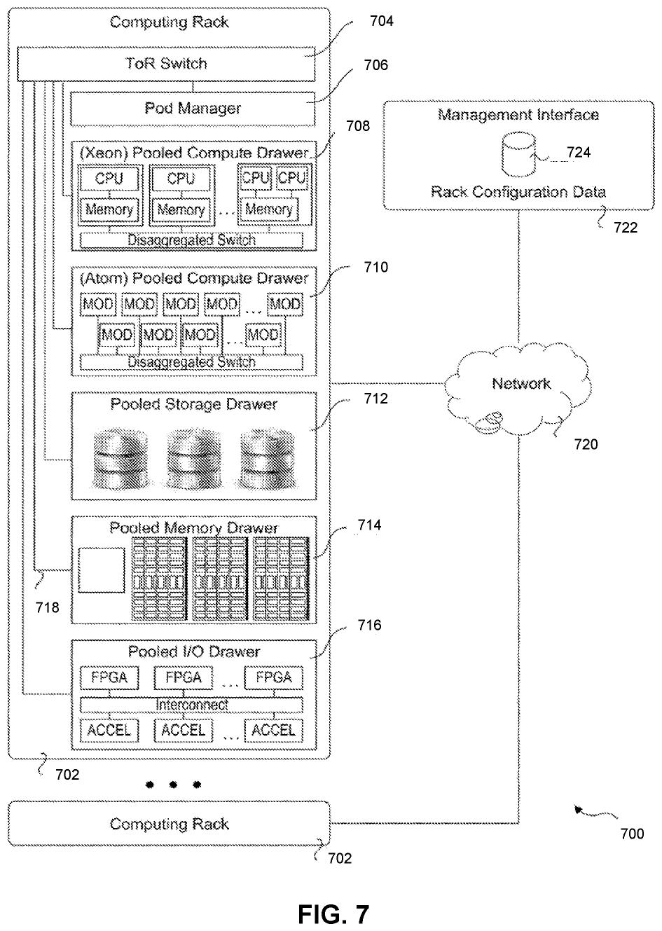

FIG. 7 depicts an environment 700 includes multiple computing racks 702, each including a Top of Rack (ToR) switch 704, a pod manager 706, and a plurality of pooled system drawers. The environment can use embodiments described herein to write telemetry information to registers and adjust resource allocation according to an application resource adjustment scheme. Generally, the pooled system drawers may include pooled compute drawers and pooled storage drawers. Optionally, the pooled system drawers may also include pooled memory drawers and pooled Input/Output (I/O) drawers. In the illustrated embodiment the pooled system drawers include an Intel® XEON® pooled computer drawer 708, and Intel® ATOM™ pooled compute drawer 710, a pooled storage drawer 712, a pooled memory drawer 714, and a pooled I/O drawer 716. Each of the pooled system drawers is connected to ToR switch 704 via a high-speed link 718, such as a 40 Gigabit/second (Gb/s) or 100 Gb/s Ethernet link or a 100+ Gb/s Silicon Photonics (SiPh) optical link. In some embodiments, high-speed link 718 comprises an 800 Gb/s SiPh optical link.

Multiple of the computing racks 702 may be interconnected via their ToR switches 704 (e.g., to a pod-level switch or data center switch), as illustrated by connections to a network 720. In some embodiments, groups of computing racks 702 are managed as separate pods via pod manager(s) 706. In some embodiments, a single pod manager is used to manage all of the racks in the pod. Alternatively, distributed pod managers may be used for pod management operations.

Environment 700 further includes a management interface 722 that is used to manage various aspects of the environment. This includes managing rack configuration, with corresponding parameters stored as rack configuration data 724. Environment 700 can be used for computing racks.

Embodiments herein may be implemented in various types of computing and networking equipment, such as switches, routers, racks, and blade servers such as those employed in a data center and/or server farm environment. The servers used in data centers and server farms comprise arrayed server configurations such as rack-based servers or blade servers. These servers are interconnected in communication via various network provisions, such as partitioning sets of servers into Local Area Networks (LANs) with appropriate switching and routing facilities between the LANs to form a private Intranet. For example, cloud hosting facilities may typically employ large data centers with a multitude of servers. A blade comprises a separate computing platform that is configured to perform server-type functions, that is, a “server on a card.” Accordingly, each blade includes components common to conventional servers, including a main printed circuit board (main board) providing internal wiring (e.g., buses) for coupling appropriate integrated circuits (ICs) and other components mounted to the board.

Various examples may be implemented using hardware elements, software elements, or a combination of both. In some examples, hardware elements may include devices, components, processors, microprocessors, circuits, circuit elements (e.g., transistors, resistors, capacitors, inductors, and so forth), integrated circuits, ASICs, PLDs, DSPs, FPGAs, memory units, logic gates, registers, semiconductor device, chips, microchips, chip sets, and so forth. In some examples, software elements may include software components, programs, applications, computer programs, application programs, system programs, machine programs, operating system software, middleware, firmware, software modules, routines, subroutines, functions, methods, procedures, software interfaces, APIs, instruction sets, computing code, computer code, code segments, computer code segments, words, values, symbols, or any combination thereof. Determining whether an example is implemented using hardware elements and/or software elements may vary in accordance with any number of factors, such as desired computational rate, power levels, heat tolerances, processing cycle budget, input data rates, output data rates, memory resources, data bus speeds and other design or performance constraints, as desired for a given implementation. It is noted that hardware, firmware and/or software elements may be collectively or individually referred to herein as “module,” or “logic.” A processor can be one or more combination of a hardware state machine, digital control logic, central processing unit, or any hardware, firmware and/or software elements.

Some examples may be implemented using or as an article of manufacture or at least one computer-readable medium. A computer-readable medium may include a non-transitory storage medium to store logic. In some examples, the non-transitory storage medium may include one or more types of computer-readable storage media capable of storing electronic data, including volatile memory or non-volatile memory, removable or non-removable memory, erasable or non-erasable memory, writeable or re-writeable memory, and so forth. In some examples, the logic may include various software elements, such as software components, programs, applications, computer programs, application programs, system programs, machine programs, operating system software, middleware, firmware, software modules, routines, subroutines, functions, methods, procedures, software interfaces, API, instruction sets, computing code, computer code, code segments, computer code segments, words, values, symbols, or any combination thereof.

According to some examples, a computer-readable medium may include a non-transitory storage medium to store or maintain instructions that when executed by a machine, computing device or system, cause the machine, computing device or system to perform methods and/or operations in accordance with the described examples. The instructions may include any suitable type of code, such as source code, compiled code, interpreted code, executable code, static code, dynamic code, and the like. The instructions may be implemented according to a predefined computer language, manner or syntax, for instructing a machine, computing device or system to perform a certain function. The instructions may be implemented using any suitable high-level, low-level, object-oriented, visual, compiled and/or interpreted programming language.

One or more aspects of at least one example may be implemented by representative instructions stored on at least one machine-readable medium which represents various logic within the processor, which when read by a machine, computing device or system causes the machine, computing device or system to fabricate logic to perform the techniques described herein. Such representations, known as “IP cores” may be stored on a tangible, machine readable medium and supplied to various customers or manufacturing facilities to load into the fabrication machines that actually make the logic or processor.

The appearances of the phrase “one example” or “an example” are not necessarily all referring to the same example or embodiment. Any aspect described herein can be combined with any other aspect or similar aspect described herein, regardless of whether the aspects are described with respect to the same figure or element. Division, omission or inclusion of block functions depicted in the accompanying figures does not infer that the hardware components, circuits, software and/or elements for implementing these functions would necessarily be divided, omitted, or included in embodiments.

Some examples may be described using the expression “coupled” and “connected” along with their derivatives. These terms are not necessarily intended as synonyms for each other. For example, descriptions using the terms “connected” and/or “coupled” may indicate that two or more elements are in direct physical or electrical contact with each other. The term “coupled,” however, may also mean that two or more elements are not in direct contact with each other, but yet still co-operate or interact with each other.

The terms “first,” “second,” and the like, herein do not denote any order, quantity, or importance, but rather are used to distinguish one element from another. The terms “a” and “an” herein do not denote a limitation of quantity, but rather denote the presence of at least one of the referenced items. The term “asserted” used herein with reference to a signal denote a state of the signal, in which the signal is active, and which can be achieved by applying any logic level either logic 0 or logic 1 to the signal. The terms “follow” or “after” can refer to immediately following or following after some other event or events. Other sequences of steps may also be performed according to alternative embodiments. Furthermore, additional steps may be added or removed depending on the particular applications. Any combination of changes can be used and one of ordinary skill in the art with the benefit of this disclosure would understand the many variations, modifications, and alternative embodiments thereof.

Disjunctive language such as the phrase “at least one of X, Y, or Z,” unless specifically stated otherwise, is otherwise understood within the context as used in general to present that an item, term, etc., may be either X, Y, or Z, or any combination thereof (e.g., X, Y, and/or Z). Thus, such disjunctive language is not generally intended to, and should not, imply that certain embodiments require at least one of X, at least one of Y, or at least one of Z to each be present. Additionally, conjunctive language such as the phrase “at least one of X, Y, and Z,” unless specifically stated otherwise, should also be understood to mean X, Y, Z, or any combination thereof, including “X, Y, and/or Z.”’

Illustrative examples of the devices, systems, and methods disclosed herein are provided below. An embodiment of the devices, systems, and methods may include any one or more, and any combination of, the examples described below.

Flow diagrams as illustrated herein provide examples of sequences of various process actions. The flow diagrams can indicate operations to be executed by a software or firmware routine, as well as physical operations. In some embodiments, a flow diagram can illustrate the state of a finite state machine (FSM), which can be implemented in hardware and/or software. Although shown in a particular sequence or order, unless otherwise specified, the order of the actions can be modified. Thus, the illustrated embodiments should be understood only as an example, and the process can be performed in a different order, and some actions can be performed in parallel. Additionally, one or more actions can be omitted in various embodiments; thus, not all actions are required in every embodiment. Other process flows are possible.

Various components described herein can be a means for performing the operations or functions described. Each component described herein includes software, hardware, or a combination of these. The components can be implemented as software modules, hardware modules, special-purpose hardware (e.g., application specific hardware, application specific integrated circuits (ASICs), digital signal processors (DSPs), etc.), embedded controllers, hardwired circuitry, and so forth.

What is claimed is:

1. A method comprising:
a core executing an application, the application configured to write application performance measurements to one or more telemetry registers associated with the core, the one or more telemetry registers designated for the application to store performance measurements from the application;
an orchestrator reading the one or more telemetry registers associated with the core; and
the orchestrator selectively causing modification of resource allocation to the application based on read contents of the one or more telemetry registers.

2. The method of claim 1, wherein utilization of the core is 100% and the performance measurements indicate a level of busyness of the application.

3. The method of claim 1, wherein the performance measurements comprise one or more of: application busyness level, packets processed over a time interval, number of packets dropped over a time interval, number of video frames processed over a time interval, writes per second, read per second, or number of pending writes.

4. The method of claim 1, wherein the orchestrator comprises a trusted entity and is permitted to read contents of the one or more telemetry registers.

5. The method of claim 1, wherein the telemetry registers are associated with only the application and the read contents with specific types of performance measurements.

6. The method of claim 1, wherein the orchestrator is to apply a decision scheme to modify resource allocation to the application based on the performance measurements, wherein the resource allocation comprises one or more of: processor frequency, cache allocation, memory allocation, network interface bandwidth allocation, or server composition.

7. The method of claim 6, wherein the orchestrator is configured to apply a particular decision scheme for a particular application, wherein the decision scheme for one application is different than a decision scheme applied for another application.

8. A non-transitory computer-readable medium comprising instructions stored thereon, that if executed by a processor, cause the processor to perform a workload that is to:
write performance measurements to one or more telemetry registers associated with the processor, the one or more telemetry registers exclusively designated for the workload to store performance measurements of the workload.

9. The non-transitory computer-readable medium of claim 8, wherein the processor that executes the workload executes the workload within a virtualized execution environment.

10. The non-transitory computer-readable medium of claim 8, wherein the performance measurements comprise one or more of: application busyness level, packets processed over a time interval, number of packets dropped over a time interval, number of video frames processed over a time interval, writes per second, read per second, or number of pending writes.

11. The non-transitory computer-readable medium of claim 8, comprising instructions stored thereon, that if executed by a processor, cause the processor to perform an orchestrator that is to:
read the one or more telemetry registers associated with the processor that executes the workload;
identify type of performance measurements associated with content read from registers based on an identification of the processor and register identifiers; and
modify resource allocation to the workload based at least on identified types of performance measurements and the performance measurements.

12. The non-transitory computer-readable medium of claim 11, wherein the orchestrator comprises a trusted entity that is permitted to read contents of the one or more telemetry registers.

13. The non-transitory computer-readable medium of claim 11, wherein the orchestrator is configured to associate contents of the one or more telemetry registers with only the workload.

14. The non-transitory computer-readable medium of claim 11, wherein the orchestrator is to apply a decision scheme to modify resource allocation to the workload based on the performance measurements, wherein the resource allocation comprises one or more of: processor frequency, cache allocation, memory allocation, network interface bandwidth allocation, or server composition.

15. The non-transitory computer-readable medium of claim 14, wherein the orchestrator is configured to apply a particular decision scheme for a particular workload, wherein the decision scheme for one workload is different than a decision scheme used for another workload.

16. An apparatus comprising:
a core and
a set of registers allocated for the core, wherein the core is permitted to configure one or more registers solely to store telemetry information, the one or more registers designated to store performance measurements.

17. The apparatus of claim 16, wherein the core is to execute the application within a virtualized execution environment.

18. The apparatus of claim 16, wherein the performance measurements comprise one or more of: application busyness level, packets processed over a time interval, number of packets dropped over a time interval, number of video frames processed over a time interval, writes per second, read per second, or number of pending writes.

19. The apparatus of claim 16, comprising a second core, the second core to execute a service assurance agent to:
modify resource allocation to the application based on the performance measurements, wherein the resource allocation comprises one or more of: processor frequency, cache allocation, memory allocation, network interface bandwidth allocation, or server composition.

20. The apparatus of claim 19, wherein the service assurance agent is configured to apply a decision scheme associated specifically with the application to modify resource allocation to the application based on the performance measurements.
